(19) United States
(12) Patent Application Publication
(10) Pub. No.: US 2005/0257989 A1
(43) Pub. Date: Nov. 24, 2005

(54) Small-sized vehicle

(76) Inventors: Kazuaki Iwami, Shizuoka (JP); Akihiro Tsuzuki, Shizuoka (JP)

Correspondence Address: KEATING & BENNETT, LLP, 8180 GREENSBORO DRIVE, SUITE 850, MCLEAN, VA, 22102, US

(21) Appl. No.: 10/975,599

(22) Filed: Oct. 28, 2004

Related U.S. Application Data
(60) Provisional application No. 60/573,416, filed on May 24, 2004.

(51) Int. Cl. B62D 5/04

(52) U.S. Cl. 180/443

(57) ABSTRACT

A small-sized vehicle achieves improved cooling performance for an electric motor of a power steering apparatus. The small-sized vehicle includes a power steering apparatus, a steering force transmission mechanism, and an engine output transmission mechanism that are mounted in this order from top to bottom, and the electric motor of the power steering apparatus is arranged such that a motor axis thereof extends along a planar surface that is substantially perpendicular to a steering shaft and the electric motor is located in a range from the left oblique rear position to the right oblique rear position of the steering shaft so as to be disposed in front of the steering shaft.

Applicant(s) claim(s) benefit under 35 U.S.C. § 119(e) of U.S. provisional application No. 60/573,416 filed May 24, 2004.

### BACKGROUND OF THE INVENTION

1. Field of the Invention

The present invention relates to, for example, a steering system for a small-sized vehicle such as a saddle type three-wheel or four-wheel vehicle used for farming, an ATV (All Terrain Vehicle) for sportive traveling off-road, a golf cart, and other small-sized vehicles. More specifically, the present invention relates to a steering system having a power steering apparatus.

2. Description of the Related Art

Generally, a small-sized vehicle used for traveling off-road has the following structure. Front and rear wheels each having a balloon tire with low pressure and wide diameter are disposed at front and rear portions of a vehicle body frame, and an engine unit is mounted between the front and rear wheels. Further, a steering shaft is arranged between the left and right front wheels, and a wheel-type steering handle or a bar-type steering handle is attached to the upper end of the steering shaft. A small-sized vehicle of this kind can travel off-road at will by turning the steering handle from side to side.

In recent years, some users expect further operational improvements when maneuvering the small-sized vehicle so as to reduce a load on operating the steering handle.

Accordingly, an electric motor-driven power steering apparatus which is connected to a steering shaft to thereby supply the steering shaft with an assisting steering force from the electric motor has been suggested.

In the above-described power steering apparatus, the electric motor operates at an extreme high temperature while steering since it is always in operation and thereby generates heat. Therefore, the electric motor must be cooled such that the electric motor can operate without problems or malfunction. Further, the center of gravity of the front portion of the vehicle is raised depending upon the location of the power steering apparatus.

### SUMMARY OF THE INVENTION

To overcome the problems described above, preferred embodiments of the present invention provide a small-sized vehicle including an electric motor-driven power steering apparatus, wherein the small-sized vehicle has outstanding cooling performance for an electric motor, and also has a lower center of gravity of the front portion of the vehicle.

According to preferred embodiments of the present invention, a steering shaft supported by the vehicle body frame in a steerable manner, a power steering apparatus supplying the steering shaft with an assisting steering force, a steering force transmission mechanism transmitting an output of the power steering apparatus to left and right front wheels, and an engine output transmission mechanism transmitting an output of an engine by divaricating the output to the left and right front wheels, are arranged in this order from top to bottom, and an electric motor of the power steering apparatus is arranged such that an axis of the electric motor is arranged along a planar surface that is substantially perpendicular to the steering shaft and is located within a range from a left oblique rear position to a right oblique rear position of the steering shaft so as to be disposed in front of the steering shaft.

According to preferred embodiments of the present invention, the engine output transmission mechanism is mounted at the bottom, and the power steering apparatus is mounted thereon. Furthermore, the electric motor, being the heaviest component in the power steering apparatus, is mounted such that its axis is located on the planar surface that is substantially perpendicular to the steering shaft. That is, the electric motor is mounted substantially horizontally. Therefore, as compared to an electric motor that is arranged vertically, as an example, the center of gravity of the front portion of the vehicle is prevented from rising.

Further, the electric motor is arranged such that the motor axis is arranged within a range on a planar surface that is substantially perpendicular to the steering shaft, from a left oblique rear position to a right oblique rear position of the steering shaft so as to be disposed in front of the steering shaft. Specifically, the electric motor is arranged in a forward portion of the vehicle without being disposed on the rear side of the reduction gear of the power steering apparatus or the steering shaft. Accordingly, moving air is easily transmitted to the electric motor, such that the temperature of the electric motor is prevented from increasing due to heat generation.

According to one preferred embodiment of the present invention, the vehicle body frame includes left and right upper and lower frame members arranged at upper and lower positions and extending in the front to rear direction of the vehicle, and left and right horizontal frame members arranged between the upper and lower frame members and extending in the front to rear direction of the vehicle, in which the power steering apparatus couples the left and right horizontal frame members to each other.

In this preferred embodiment, the power steering apparatus defines a reinforcing member for coupling the left and right horizontal pipes to each other. Accordingly, the stiffness of the vehicle frame is improved.

According to another preferred embodiment the present invention, the power steering apparatus and the engine output transmission mechanism are supported by the front portion of the lower frame member of the vehicle body frame.

In this preferred embodiment, both the engine output transmission mechanism and power steering apparatus, which are relatively heavy, are arranged on the lower pipe located at a lower portion of the vehicle, such that the center of gravity of the vehicle is prevented from rising.

According to still another preferred embodiment of the present invention, the engine output transmission mechanism is supported by the front portion of the lower frame member, while the power steering apparatus is supported by the front portion of the lower frame member via the engine output transmission mechanism.

In this preferred embodiment, the power steering apparatus is supported not directly by the lower frame, but indirectly by the lower frame via the engine output transmission mechanism. Specifically, the engine output transmission mechanism is used as a bracket for supporting the power steering apparatus, and therefore, a separate bracket for supporting the power steering apparatus on the lower frame can be reduced in size and simplified in shape, or eliminated.

According to still another preferred embodiment of the present invention, both of the power steering apparatus and a swingable arm on the upper side of a front-wheel suspension system are supported by the horizontal frame member and both of the engine output transmission mechanism and a swingable arm on the lower side of the front-wheel suspension system are supported by the front portion of the lower frame member.

In this preferred embodiment, the power steering apparatus and the engine output transmission mechanism are supported by the horizontal frame member for supporting the upper arm of the front-wheel suspension system and the lower frame member for supporting the lower arm of the front-wheel suspension system, respectively, such that the required number of vehicle components is reduced, and the structure of the power steering apparatus is simplified.

According to still another preferred embodiment of the present invention, in a space surrounded by the front-end vertical frame member, the horizontal frame member, the intermediate vertical frame member, and the lower frame member, a ball joint disposed on a pitman arm of the steering force transmission mechanism and an output shaft of the engine output transmission mechanism are disposed, which prevents the size of the apparatus from increasing.

According to still another preferred embodiment of the present invention, a shock absorber of the front-wheel suspension system is arranged in front of the power steering apparatus, and a coupling portion of the shock absorber on the vehicle side is supported by the front-end vertical frame member or the upper frame member.

In this preferred embodiment, the shock absorber is supported by a portion that is different from the portion on which the power steering apparatus is mounted, such that the power steering apparatus is not affected by a load generated by an impact with a road surface.

Other features, elements, steps, characteristics and advantages of the present invention will become more apparent from the following detailed description of preferred embodiments with reference to the attached drawings.

### BRIEF DESCRIPTION OF THE DRAWINGS

FIG. 1 is a left side view of a small-sized vehicle for traveling off-road according to a first preferred embodiment of the present invention, in which some components are shown by solid lines, and some components are shown by chain-double dashed lines and dotted lines;

FIG. 2 is a left side view of a periphery of a steering system in the small-sized vehicle, in which frame components are shown by chain-double dashed lines and the steering system and so forth are shown by solid lines;

FIG. 3 is a plan view showing an arrangement of the power steering apparatus according to the above-described preferred embodiment of the present invention;

FIG. 4 is a schematic plan view illustrating the available area for arranging the electric motor of the power steering apparatus according to a preferred embodiment of the present invention; and

FIG. 5 is a left side view of a periphery of a steering system of a preferred embodiment according to the present invention, in which frame parts are shown by chain-double dashed lines and a steering system and so forth are shown by solid lines.

### DETAILED DESCRIPTION OF PREFERRED EMBODIMENTS

Hereinafter, preferred embodiments according to the present invention will be described with reference to the attached drawings. Note that the indications of front, rear, left, and right in the description of these preferred embodiments represent the front, rear, left, and right when viewed from an operator seated on a seat of the vehicle.

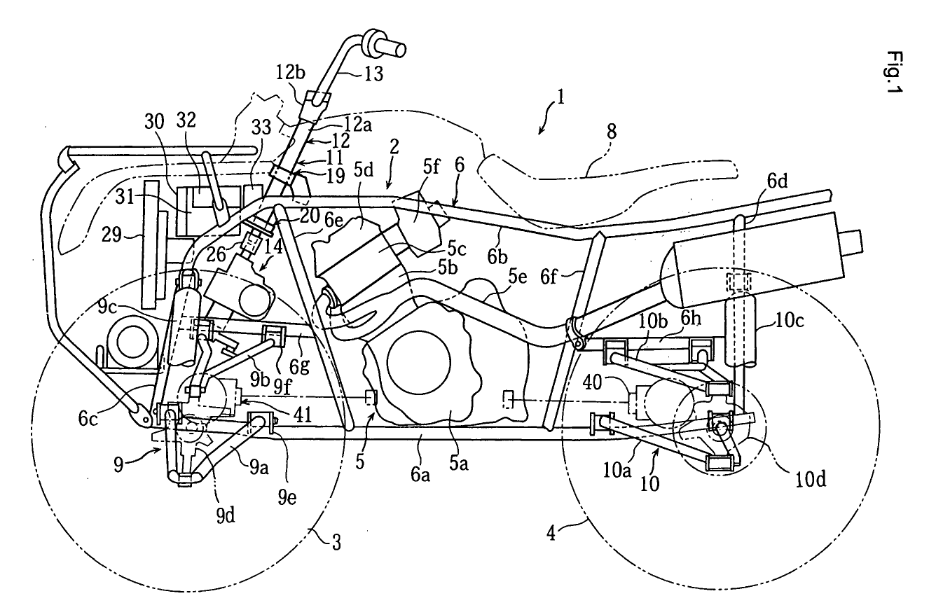

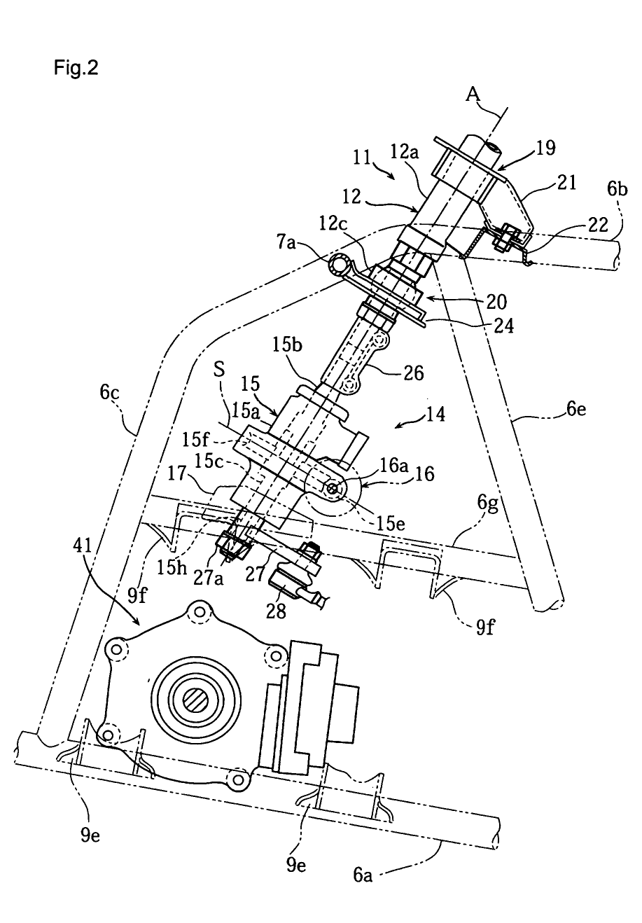

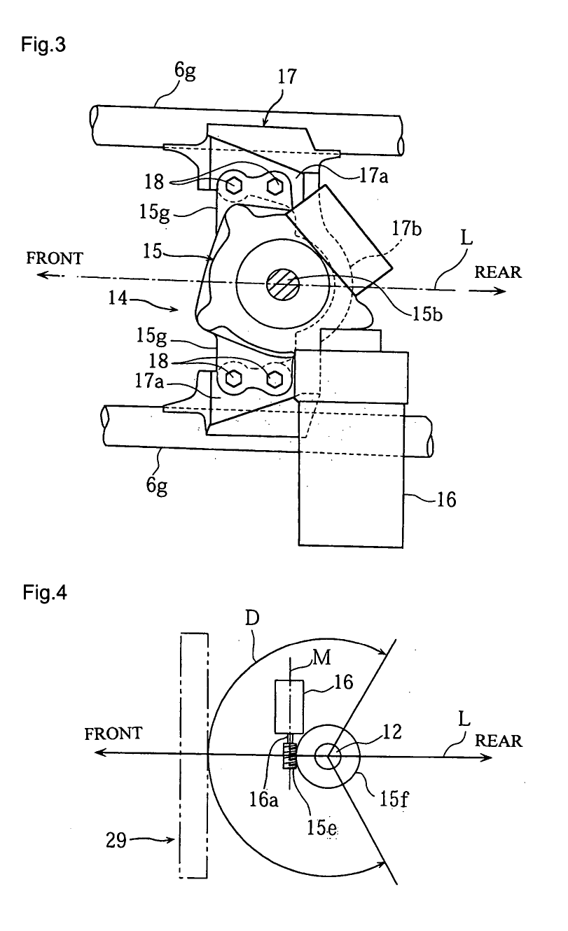

In FIG. 1 to FIG. 4, “1” denotes a small-sized vehicle for traveling off-road. This small-sized vehicle 1 includes a vehicle body frame 2, left and right front wheels 3, 3 arranged at left and right front portions of the vehicle body frame 2, left and right rear wheels 4, 4 disposed at left and right rear portions of the vehicle body frame 2, an engine unit 5 mounted between the front wheel 3 and the rear wheel 4 of the vehicle body frame 2, and a steering system 11 disposed between the left and right front wheels 3, 3.

The vehicle body frame 2 is a double cradle type frame in which left and right side frames 6, 6 are connected by a plurality of cross pipes. Each of the side frames 6 has a lower pipe (lower frame member) 6a arranged approximately at a height of the axes of the front and rear wheels 3, 4 and extending in the front to rear direction of the vehicle, and an upper pipe (upper frame member) 6b arranged approximately at a height of the lower end of a saddle type seat 8 and extending in the front to rear direction of the vehicle. At the front end portion of the upper pipe 6b, a front-end vertical pipe (front-end vertical frame member) 6c is formed by bending the upper pipes 6b downward. The lower end portion of the front-end vertical pipe 6c is connected to the front end portion of the lower pipe 6a. Further, the lower pipe 6a and the upper pipe 6b are connected with each other by a rear-end vertical pipe 6d, and an intermediate vertical pipe (intermediate vertical frame member) 6e on the front side and an intermediate vertical pipe 6f on the rear side, respectively. Furthermore, the front-end vertical pipe 6c and the intermediate vertical pipe 6e on the front side, and the rear-end vertical pipe 6d and the intermediate vertical pipe 6f on the rear side are coupled to each other by intermediate horizontal pipes (horizontal frame members) 6g, 6h substantially arranged in parallel with the lower pipe 6a, respectively.

The engine unit 5 is mounted in a space surrounded by the lower and upper pipes 6a, 6b, and the front and rear intermediate vertical pipes 6e, 6f. In front of an engine case 5a having a built-in crankshaft of the engine unit 5 and a built-in variable speed gear, a cylinder block 5b, a cylinder head 5c, and a head cover 5d are stacked and fastened. Further, an exhaust system 5e is connected to the front wall of the cylinder head 5c. The exhaust system 5e extends rearward at the height of the cylinder block 5b. Further, a carburetor 5f is connected to the rear wall of the cylinder head 5c.

In front of the steering system 11, a radiator 29 provided for cooling the cooling water of the engine unit 5 with moving air. Further, between the radiator 29 and the steering system 11, various vehicle components are provided, such as a battery 30, a control unit 31 for the engine unit 5, a control unit 32 for a power steering apparatus which will be described later, a relay 33, and other components.

The left and right front wheels 3, 3 are supported by a double wishbone type front-wheel suspension system 9 in a vertically swingable and horizontally steerable manner. The front-wheel suspension system 9 includes a lower arm (swingable arm on the lower side) 9a supported by the front portion of the lower pipe 6a in a vertically swingable manner, an upper arm (swingable arm on the upper side) 9b supported by the intermediate horizontal pipe 6g on the front side in a vertically swingable manner, and a shock absorber 9c disposed between the front-end vertical pipe 6c and the lower arm 9a. The lower arm 9a is axially supported by lower brackets 9e, 9e that are connected to the lower pipe 6a, and the upper arm 9b is axially supported by upper brackets 9f, 9f that are connected to the intermediate horizontal pipes 6g.

Also, the left and right rear wheels 4, 4 are supported by a double wishbone type rear-wheel suspension system 10 in a vertically swingable manner. The rear-wheel suspension system 10 includes a lower arm 10a supported by the rear portion of the lower pipe 6a in a vertically swingable manner, an upper arm 10b supported by the intermediate horizontal pipe 6h on the rear side in a vertically swingable manner, and a shock absorber 10c disposed between the rear-end vertical pipe 6d and the lower arm 10a.

Between tip portions of the lower arm 9a and the upper arm 9b, a knuckle 9d for the front wheel is coupled to the lower arm 9a and the upper arm 9b, respectively, via a ball joint and supporting the front wheel 3 in a rotatable manner. Similarly, between the lower arm 10a and the upper arm 10b, a knuckle 10d for the rear wheel is coupled to the lower arm 10a and the upper arm 10b, respectively, in an axially rotatable manner and supporting the rear wheel 4 in a rotatable manner.

Between the front portions of the left and right lower pipes 6a, 6a, a front differential gear 41 is provided which functions as an engine output transmission mechanism for transmitting an output of an engine to the left and right front wheels 3, 3. Further, between the rear portions of the left and right lower pipes 6a, 6a, a reduction bevel gear (rear differential gear) 40 is provided which functions as an engine output transmission mechanism for transmitting the output of the engine to the left and right rear wheels 4, 4.

The steering system 11 includes a steering shaft 12 arranged substantially at the center of the front wheels 3, 3, a steering handle 13 attached to the upper end of the steering shaft 12, and an electric motor-driven power steering apparatus 14 connected to the lower end of the steering shaft 12. The steering shaft 12 and an input shaft and an output shaft of the power steering apparatus 14 form a substantially straight line so as to tilt rearward in the front to rear direction of the vehicle 1.

The power steering apparatus 14 includes a reduction gear 15 and an electric motor 16 integrally fixed to a reduction gear case 15a of the reduction gear 15. In the reduction gear case 15a, an input shaft 15b and an output shaft 15c are substantially coaxially arranged. The input and output shafts 15b, 15c are integrally coupled, and are rotatably supported by the reduction gear case 15a via a bearing. A worm wheel 15f is fixed to the output shaft 15c, and the worm wheel 15f is engaged with a worm 15e fixed to the output shaft 16a of the electric motor 16.

The input shaft 15b defines an input section of a direct steering force by an operator. Inside the reduction gear 15, an assisting steering force output by the electric motor 16 together with a predetermined gain corresponding to the direct steering force is added to the direct steering force. The output shaft 15c defines an output section of the combined force of the direct steering force and the assisting steering force. The reduction gear 15 is provided with a detection sensor (not shown) for detecting the direct steering force, or a speed sensor (not shown) for detecting a rotation speed of the input shaft 15b, such that the output torque and the output rotation speed are controlled in response to the detected values.

The electric motor 16 is arranged such that the engaged portion of the worm 15e and the worm wheel 15f is located rearward of the steering shaft 12 in the vehicle, and an axis M of the electric motor 16 is arranged on a planar surface S that is substantially perpendicular to an axis A of the steering shaft 12. Accordingly, the electric motor 16 is arranged so as to be displaced to one side in the vehicle width direction (on the left side in the present preferred embodiment) from the center line L in the vehicle width direction.

According to preferred embodiments of the present invention, as shown by an arrow D in FIG. 4, the electric motor 16 is arranged such that the motor axis M is preferably located within a range on the planar surface S from the left oblique rear position to the right oblique rear position of the steering shaft 12 so to be disposed in front of the steering shaft 12.

Further, a steering force transmission mechanism transmitting the steering force to the left and right front wheels 3, 3 is connected to a lower-end portion 15h of the output shaft 15c protruding downward from the reduction gear case 15a. The steering force transmission mechanism is provided with a pitman arm 27 fastened and fixed to the lower-end portion 15h by a nut 27a, a ball joint 28 attached to the pitman arm 27, and a tie rod (not shown) connected to the ball joint 28. The tie rod is connected with the knuckle 9d for the front wheel.

A mounting flange 15g integrally formed at the lower portion of the reduction gear case 15a is connected to a supporting bracket 17 by bolts 18. The supporting bracket 17 has left and right supporting boss portions 17a, 17a and a coupling portion 17b for coupling the supporting boss portions 17a, 17a to each other. The left and right supporting boss portions 17a, 17a are fixed over the left and right intermediate horizontal pipes 6g, 6g. The coupling portion 17b has an arc shape along the outer periphery of the reduction gear case 15a, and the coupling portion 17b is disposed in the vicinity of the outer peripheral surface of the reduction gear case 15a.

The steering shaft 12 has a substantially cylindrical column portion 12a, a bracket 12b for mounting a handle which is fixed to the upper end portion of the substantially cylindrical column portion 12a and to which the steering handle 13 can be mounted in a detachable manner, and a coupling shaft portion 12c fixed coaxially at the lower end portion thereof.

The lower end portion of the coupling shaft portion 12c and the input shaft 15b of the power steering apparatus 14 are coupled to each other by a serration coupling pipe 26.

The vertical intermediate portion of the column portion 12a is axially supported by an upper bearing 19, and the coupling shaft portion 12c is axially supported by a lower bearing 20. A bracket 21 is connected with the upper bearing 19, and the bracket 21 is connected by a bolt to a base bracket 22 fixed between the left and right upper pipes 6b, 6b. The lower bearing 20 is connected by a bolt to a bracket 24 that is fixed to a cross pipe 7a. The cross pipe 7a is fixed between the left and right upper pipes 6b, 6b.

Here, in the present preferred embodiment, the steering shaft 12, the power steering apparatus 14, the pitman arm 27 functioning as a steering force transmission mechanism, the ball joint 28, and the front differential gear 41 functioning as an engine output transmission mechanism are mounted in this order from top to bottom. Specifically, the heaviest front differential gear 41 is arranged at the bottom, and the power steering apparatus 14 is mounted thereon. Furthermore, the electric motor 16 being the heaviest component in the power steering apparatus 14 is mounted such that its axis M is arranged on the planar surface S that is substantially perpendicular to the steering shaft 12. That is, the electric motor 16 is mounted substantially horizontally. Therefore, as compared to the case where the electric motor is arranged vertically, as an example, the center of gravity of the vehicle front portion is lowered.

The electric motor 16 is arranged such that the motor axis M is located, as shown by the arrow D, within the range, on the planar surface S that is substantially perpendicular to the steering shaft 12, from the left oblique rear position to the right oblique rear position of the steering shaft 12 so as to be disposed in front of the steering shaft 12. Specifically, the electric motor 16 is arranged in a forward portion of the vehicle without being disposed on the rear side of the reduction gear 15 or the steering shaft 12. Accordingly, the moving air is easily transmitted to the electric motor 16, such that the temperature of the electric motor 16 is prevented from increasing due to heat generation.

The reduction gear 15 of the power steering apparatus 14 functions as a reinforcing member for coupling the left and right intermediate horizontal pipes 6g, 6g to each other. Accordingly, the stiffness of the vehicle frame 6 is improved.

Both of the power steering apparatus 14 and the upper arm 9b of the front-wheel suspension system 9 are supported by the intermediate horizontal pipe 6g, and both of the front differential gear 41 and the lower arm 9a of the front-wheel suspension system 9 are supported by the front portion of the lower pipe 6a, such that the number of vehicle components is reduced, and the structure of the power steering apparatus 14 is simplified.

Further in the space surrounded by the front-end vertical pipe 6c, the intermediate horizontal pipe 6g, the intermediate vertical pipes 6e, and the lower pipe 6a, the ball joint 28 disposed on the pitman arm 27 of the steering force transmission mechanism and the output shaft of the front differential gear 41 are arranged, such that the size of the apparatus is not increased.

A shock absorber 9c of the front-wheel suspension system 9 is arranged in front of the power steering apparatus 14, and the coupling portion of the shock absorber 9c on a vehicle body side is provided on the front-end vertical pipe 6c. Specifically, the shock absorber 9c is supported by a different portion of the vehicle body frame 2 from the portion on which the power steering apparatus 14 is mounted, such that the power steering apparatus 14 is prevented from affected by a load generated by impact with a road surface.

Incidentally, in the above-described preferred embodiment, the power steering apparatus 14 is supported preferably by the intermediate horizontal pipes 6g for supporting the upper arm 9b of the front-wheel suspension system 9. However, with the use of a bracket, the power steering apparatus 14 can be supported by the lower pipe 6a supporting the front differential gear 41.

Such a structure is useful when the front-wheel suspension system 9 requires no intermediate horizontal pipe 6g for supporting the upper arm, as in the case when a MacPherson strut suspension is used. In this case, the power steering apparatus 14 and the front differential gear 41, both of which are heavy, are arranged on the lower pipe 6a located at a lower portion of the vehicle, such that the center of gravity of the vehicle is prevented from rising.

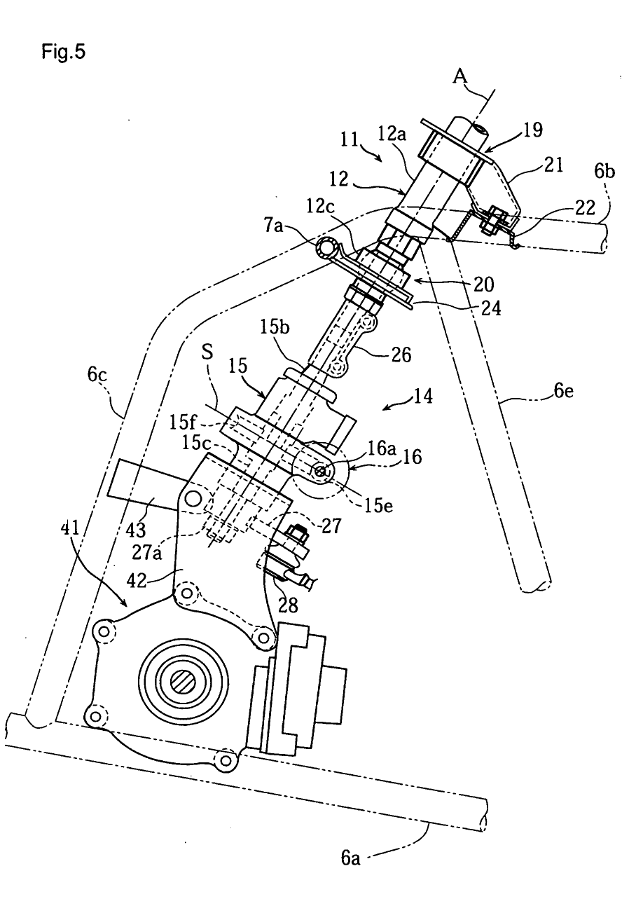

FIG. 5 shows a modified example of a structure for supporting a power steering apparatus 14. In this modified example, a front differential gear 41 is supported by a front portion of a lower pipe 6a. Meanwhile, the power steering apparatus 14 is connected to a bracket 42 that is fixed to the front differential gear 41. Specifically, the power steering apparatus 14 is supported by the front portion of the lower pipe 6a via the front differential gear 41. Furthermore, the bracket 42 is fastened and fixed by a bolt to a bracket 43 fixed to a front-end vertical pipe 6c.

In this modified example, the power steering apparatus 14 is supported not directly by the lower pipe 6a, but indirectly by the lower pipe 6a via the front differential gear 41. Specifically, the front differential gear 41 is used as a bracket when supporting the power steering apparatus 14, and therefore, the bracket 42 for supporting the power steering apparatus 14 by a lower pipe 6a is reduced in size and simplified in shape.

Incidentally, in the above-described preferred embodiments, a front differential gear 41 is preferably used as one mechanism for transmitting an engine output to left and right wheels, and a reduction bevel gear 40 is preferably used as one mechanism for transmitting the engine output to left and right rear wheels. However, it is also possible to use the differential gear for both the rear and front, the reduction bevel gear for the front and the differential gear for the rear, or the differential gear for both the front and rear.

While the present invention has been described with respect to preferred embodiments, it will be apparent to those skilled in the art that the disclosed invention may be modified in numerous ways and may assume many embodiments other than those specifically set out and described above. Accordingly, it is intended by the appended claims to cover all modifications of the invention which fall within the true spirit and scope of the invention.

1. A vehicle comprising:
a vehicle body frame;
a steering shaft supported by said vehicle body frame in a steerable manner;
a power steering apparatus supplying said steering shaft with an assisting steering force and including an electric motor;
a steering force transmission mechanism transmitting an output of said power steering apparatus to left and right front wheels of the vehicle; and
an engine output transmission mechanism transmitting an output of an engine by divaricating the output to the left and right front wheels; wherein
said steering shaft, said power steering apparatus, said steering force transmission mechanism, and said engine output transmission mechanism are arranged in this order from top to bottom, and said electric motor of said power steering apparatus is arranged such that an axis of the electric motor is arranged along a planar surface that is substantially perpendicular to said steering shaft and is located within a range from a left oblique rear position to a right oblique rear position of said steering shaft so as to be disposed in front of said steering shaft.

2. The vehicle according to claim 1, wherein said vehicle body frame includes left and right upper and lower frame members extending in a front to rear direction of the vehicle and left and right horizontal frame members arranged between the upper and lower frame members and extending in the front to rear direction of the vehicle, and said power steering apparatus defines a cross frame member coupling the left and right horizontal frame members to each other.

3. The vehicle according to claim 1, wherein said vehicle body frame includes left and right upper and lower frame members extending in a front to rear direction of the vehicle, and said power steering apparatus and said engine output transmission mechanism are supported by a front portion of the left and right lower frame members.

4. The vehicle according to claim 1, wherein said vehicle body frame includes left and right upper and lower frame members extending in a front to rear direction of the vehicle, said engine output transmission mechanism is supported by a front portion of the left and right lower frame members, and said power steering apparatus is supported by a front portion of the left and right lower frame members via a bracket and said engine output transmission mechanism.

5. The vehicle according to claim 1, further comprising:
a front-wheel suspension system including an upper swingable arm and a lower swingable arm; wherein
said vehicle body frame includes left and right upper and lower frame members extending in a front to rear direction of the vehicle, a front-end vertical frame member coupling front end portions of the upper and lower frame members to each other, an intermediate vertical frame member coupling rear portions of the upper and lower frame members to each other, and a horizontal frame member coupling the intermediate vertical frame member and the front-end vertical frame member;
said power steering apparatus is supported by the horizontal frame member, said engine output transmission mechanism is supported by the front portion of the lower frame members; and
sand upper swingable arm is axially supported by the horizontal frame member or at approximately the same height as the horizontal frame member, and said lower swingable arm is axially supported by the front portion of the lower frame members.

6. The vehicle according to claim 5, wherein said steering force transmission mechanism includes a pitman arm, and a ball joint disposed on said pitman arm and an output shaft of said engine output transmission mechanism are arranged in a space surrounded by the front-end vertical frame member, the horizontal frame member, the intermediate vertical frame member, and the lower frame members, when viewed from a vehicle side.

7. The vehicle according to claim 5, wherein the front-wheel suspension system includes a shock absorber arranged in front of said power steering apparatus, and the shock absorber includes a coupling portion supported by the front-end vertical frame member or one of the left and right upper frame members.

8. The vehicle according to claim 5, wherein said engine output transmission mechanism includes a front differential gear supported between the left and right lower frame members.

9. The vehicle according to claim 1, wherein said electric motor is arranged so as to be displaced to one side of a center line of the vehicle in the vehicle width direction.

10. A vehicle comprising:
a vehicle body frame;
an engine supported by said vehicle frame;
left and right front wheels supported by said vehicle frame;
a steering shaft supported by said vehicle body frame;
a power steering apparatus supplying said steering shaft with an assisting steering force and including an electric motor;
a steering force transmission mechanism transmitting an output of said power steering apparatus to the left and right front wheels of the vehicle; and
an engine output transmission mechanism transmitting an output of said engine to the left and right front wheels; wherein
said steering shaft, said power steering apparatus, said steering force transmission mechanism, and said engine output transmission mechanism are arranged in this order from top to bottom, and said electric motor of said power steering apparatus is arranged such that an axis of the electric motor is arranged in a substantially horizontal plane.

11. The vehicle according to claim 10, wherein said electric motor is arranged along a planar surface that is substantially perpendicular to said steering shaft and is located within a range from a left oblique rear position to a right oblique rear position of said steering shaft so as to be disposed in front of said steering shaft.

12. The vehicle according to claim 10, wherein said vehicle body frame includes left and right upper and lower frame members extending in a front to rear direction of the vehicle and left and right horizontal frame members arranged between the upper and lower frame members and extending in the front to rear direction of the vehicle, and said power steering apparatus defines a cross frame member coupling the left and right horizontal frame members to each other.

13. The vehicle according to claim 10, wherein said vehicle body frame includes left and right upper and lower frame members extending in a front to rear direction of the vehicle, and said power steering apparatus and said engine output transmission mechanism are supported by a front portion of the left and right lower frame members.

14. The vehicle according to claim 10, wherein said vehicle body frame includes left and right upper and lower frame members extending in a front to rear direction of the vehicle, said engine output transmission mechanism is supported by a front portion of the left and right lower frame members, and said power steering apparatus is supported by a front portion of the left and right lower frame members via a bracket and said engine output transmission mechanism.

15. The vehicle according to claim 10, further comprising:
a front-wheel suspension system including an upper swingable arm and a lower swingable arm; wherein
said vehicle body frame includes left and right upper and lower frame members extending in a front to rear direction of the vehicle, a front-end vertical frame member coupling front end portions of the upper and lower members to each other, an intermediate vertical frame member coupling rear portions of the upper and lower frame members to each other, and a horizontal frame member coupling the intermediate vertical frame member and the front-end vertical frame member;
said power steering apparatus is supported by the horizontal frame member, said engine output transmission mechanism is supported by the front portion of the lower frame members; and
sand upper swingable arm is axially supported by the horizontal frame member or at approximately the same height as the horizontal frame member, and said lower swingable arm is axially supported by the front portion of the lower frame members.

16. The vehicle according to claim 15, wherein said steering force transmission mechanism includes a pitman arm, and a ball joint disposed on said pitman arm and an output shaft of said engine output transmission mechanism are arranged in a space surrounded by the front-end vertical frame member, the horizontal frame member, the intermediate vertical frame member, and the lower frame members, when viewed from a vehicle side.

17. The vehicle according to claim 15, wherein the front-wheel suspension system includes a shock absorber arranged in front of said power steering apparatus, and the shock absorber includes a coupling portion supported by the front-end vertical frame member or one of the left and right the upper frame members.

18. The vehicle according to claim 15, wherein said engine output transmission mechanism is defined by a front differential gear supported between the left and right lower frame members.

19. The vehicle according to claim 10, wherein said electric motor is arranged so as to be displaced to one side of a center line of the vehicle in the vehicle width direction.
